(19) United States
(12) Patent Application Publication
(10) Pub. No.: US 2002/0080885 A1
(43) Pub. Date: Jun. 27, 2002

(54) Combined turbo coding and trellis coded modulation

(75) Inventor: Donald C. Mead, Carlsbad, CA (US)

Correspondence Address: Attn: James W. Inskeep, OPPENHEIMER WOLFF & DONNELLY LLP, Suite 700, 500 Newport Center Drive, Newport Beach, CA, 92660, US

(73) Assignee: Digital Cinema Systems Corporation

(21) Appl. No.: 09/733,466

(22) Filed: Dec. 8, 2000

Related U.S. Application Data
(60) Provisional application No. 60/169,651, filed on Dec. 8, 1999.

(51) Int. Cl. H04L 27/04; H04L 27/12; H04L 27/20

(52) U.S. Cl. 375/295

(57) ABSTRACT

This invention discloses a technique for obtaining coding gain without sacrificing bandwidth be combining Turbo Coding with Trellis Coded Modulation.

### BACKGROUND OF THE INVENTION

1. Field of the Invention

This invention is a technique to obtain the power gain of Turbo codes but not suffer the normal bandwidth expansion that would experienced by the use of Trellis Coded Modulation (TCM).

2. Description of the Related Art

Trellis Coded Modulation (TCM) is a technique that combines coding and modulation. This permits coding gain without requiring an increase in bandwidth. Turbo coding, with recursive decoding has proved to be the most efficient coding scheme ever invented. However, it requires a significant increase in bandwidth.

### SUMMARY OF THE INVENTION

In this invention, Turbo coding and TCM are combined to provide high coding gain without sacrifice of bandwidth.

### BRIEF DESCRIPTION OF THE DRAWINGS

FIG. 1 shows a Turbo code encoder.

FIG. 2 shows a Turbo decoder.

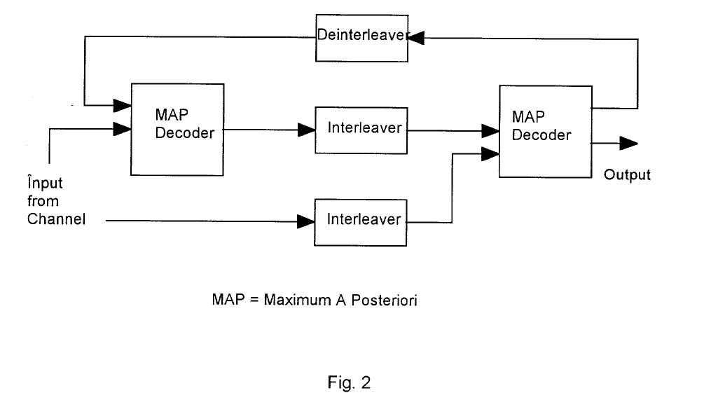

FIG. 3 shows a phase encoder with TCM.

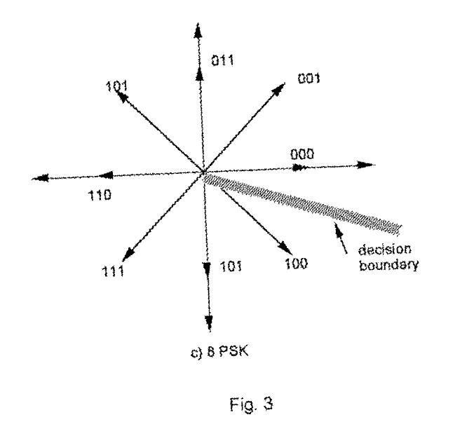

### DETAILED DESCRIPTION OF THE INVENTION

Error correcting codes have been around since the beginning of the digital age. In the beginning, the codes consisted of parity check bits that were added to a set of information bits. If the number of errors in transmission (or storage) was less than some number, the decoder could correct all of the errors, which occurred.

The search for codes intensified when Dr. Claude E. Shannon, considered to be the father of information theory, published his famous capacity theorem. Simply stated, this theorem states that if the information rate on a channel is below a value called the capacity, error free transmission can be achieved. Note that the theorem is an existence theorem: it states that a code exists, not how to find it. For the first 45 years after Shannon's theorem, no codes came close to the “Shannon limit” as it was called.

It wasn't until Dr. Gottfried Ungerboeck published his seminal paper on Trellis Coded Modulation (TCM) in 1982 that parity bits could be added without increasing the bandwidth. This was achieved by increasing the order of the modulation. An example may help clarify the situation: Consider a communication system where we wish to transmit a sequence of 2 bit messages. One way to achieve this is to send one bit at a time. Thus, each message requires 2 channel uses. Since the transmission of each bit requires a channel use, this is called Binary Phase Shift Keying (BPSK). Alternatively, we can utilize Quadrature Phase Shift Keying (QPSK), with 4 possible signals, and send both bits with one channel symbol (channel use). This requires exactly the same bandwidth as the BPSK. Consequently, QPSK has twice the bandwidth efficiency as BPSK. The bit error rate for the QPSK is higher, since the points in the signal constellation are closer together. Suppose then that the bit error rate for the QPSK is too high. The traditional solution was to use a code, say adding a parity bit to each of the 2 information bits per message. The messages can be grouped so that 3 QPSK channel uses produce 6 total bits, 4 of which are 2, 2 bit messages. The efficiency of channel usage is 4/6=⅔ and the code is said to have a rate of 2/3. The bit error rate for this case is better than the BPSK and we have gotten 4 bits with 3 channel uses instead of the 3 bits with BPSK. Ungerboeck proposed an even better idea: keep the parity bit, so we still have 3 bits per message, but use 8 PSK instead of 4-PSK. Now, each channel use yields 2 bits, so we obtain 6 information bits for 3 channel uses instead of the 4 for QPSK with a rate 2/3 code. The astute reader will note that the points in the constellation for 8 PSK are closer together than for 4 PSK; consequently, the symbol error rate will be higher for the 8 PSK. However, the beauty of the Ungerboeck codes is that if the codes for the sequence of channel uses are selected and decoded appropriately, the bit error rate can even be better than for the uncoded QPSK. In coding it is said that we have both bandwidth and power efficiency.

While coding progressed steadily between 1982 and 1993, most of the advances were the result of increased processing capability. Then, in 1993, another breakthrough occurred. Berrou, Glavieux, and Thitimajshima introduced a coding concept that they called “Turbo Codes”, which actually approached the Shannon limit.

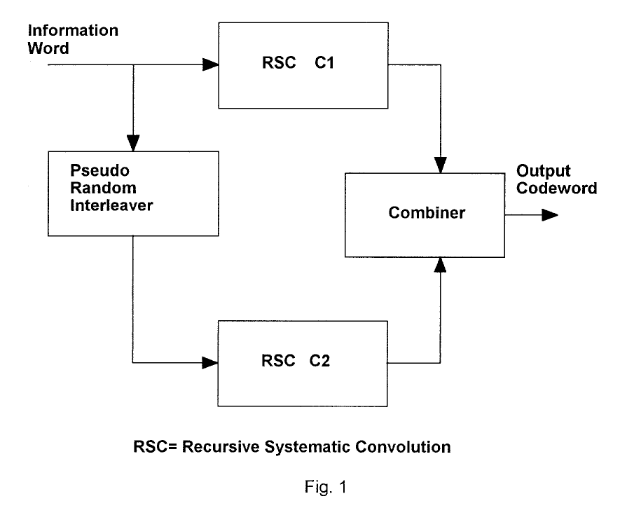

FIG. 1 shows the encoder for a parallel turbo code encoder. An information word of some number of bits enters the encoder and goes to 2 places: A Recursive Systematic Convolutional coder labeled C1 and a pseudo random interleaver (in coding language, Systematic means that the information word is a subset of the codeword). One implementation of a pseudo random interleaver would be to write the input into a rectangular memory array as determined by a pseudo random number generator and read the memory in a conventional raster mode. Since each of the RSC is systematic, part of each RSC codeword out is the input word; since this is the same for both RSC, one of the two can be discarded. The Combiner then outputs: the input word, the parity check bits from RSC C1, and the parity bits from RSC C2. In a technique called puncturing, the parity bits from RSC C1 and RSC C2 can be used alternately to improve the overall bandwidth efficiency.

To illustrate this, consider the system shown in FIG. 1. Let RSC C1 and RSC C2 be 1/2 rate encoders. An input bit creates 2 parity check bits (one from each coder) so there are 3 output bits for each input bit. Thus, the overall code rate is 1/3. This mean that 3 time as much bandwidth is required as would be required in the uncoded case. If the 3 bit outputs per input word of FIG. 1 are used to drive an 8 PSK modulator the bandwidth is the same as uncoded BPSK. Thus, we have gained the bandwidth efficiency of TCM with the power efficiency of Turbo codes.

Obviously, there are a very large number of combinations of Turbo encoders and modulators that make sense. In cases where the signal to noise is relatively high and constant, such as telephone lines and cable systems, Quadrature Amplitude Modulation (QAM)systems with a very high number of constellation points can be utilized with corresponding bandwidth efficiency.

The key to this invention is that even though the symbol error rate is higher, the decoding more than makes up for this.

What is claimed is:

1. A system for data transmission comprising:
a data signal;
an encoder operative to encode said data signal;
a modulator connected to said turbo code encoder to modulate said data signal; and,
a transmitter operative to receive said signal from said modulator and to transmit said signal.

2. A system according to claim 1, wherein said encoder is a turbo encoder.

3. A system according to claim 1, wherein said modulator is a trellis coded modulator.

4. A system according to claim 3, wherein said modulator is an N Phase Shift Key modulator.

5. A system according to claim 4, wherein said encoder is a turbo encoder that includes at least two recursive systematic convolutional coders.

6. A system according to claim 1, wherein said modulator is a quadrature amplitude modulation system.

7. A method of data transmission comprising:
generating a data signal;
encoding said signal;
modulating said signal; and,
performing said encoding and said modulating such that coding gain is maximized and bandwidth is minimized.

8. A method according to claim 7, wherein said encoding is performed with a turbo encoder.

9. A method according to claim 7, wherein said modulating is performed with a trellis coded modulator.

10. A method according to claim 7, wherein said modulating is performed with a quadrature amplitude modulation system.

11. A method according to claim 7, wherein said modulating is performed with an N Phase Shift Key modulator.

12. A method according to claim 8, wherein said turbo encoder processes said data signal with at least two recursive systematic convolutional coders.

13. A method according to claim 12, wherein parity bits from said at least two recursive systematic convolutional coders are punctured in a manner to improve bandwith efficiency.
